(19) United States
(12) Patent Application Publication
(10) Pub. No.: US 2020/0400442 A1
(43) Pub. Date: Dec. 24, 2020

(54) METHODS AND SYSTEMS FOR FILTERING POINT CLOUD MAP DATA FOR USE WITH ACQUIRED SCAN FRAME DATA

(71) Applicant: Kaarta, Inc., Pittsburgh, PA (US)

(72) Inventors: Steven Huber, Pittsburgh, PA (US); Ethan Abramson, Pittsburgh, PA (US); Ji Zhang, Pittsburgh, PA (US); Calvin Wade Sheen, Chula Vista, CA (US); Kevin Joseph Dowling, Pittsburgh, PA (US); Brian Boyle, Pittsburgh, PA (US)

(21) Appl. No.: 17/010,045

(22) Filed: Sep. 2, 2020

Related U.S. Application Data
(63) Continuation of application No. PCT/US19/22384, filed on Mar. 15, 2019.
(60) Provisional application No. 62/643,460, filed on Mar. 15, 2018.

(51) Int. Cl. G01C 21/32; G01S 17/89; G01C 21/20

(52) U.S. Cl. CPC G01C 21/32; G01C 21/206; G01S 17/89

(57) ABSTRACT

A method includes acquiring with a scanning device a scan frame comprising a point cloud comprising a first plurality of points, attributing each of the first plurality of points with a selected metric, filtering an existing map comprised of a second plurality of points based, at least in part, on the selected metric and localizing each of the first plurality of points to the filtered second plurality of points.

### STATEMENT OF PRIORITY

This application is a bypass continuation of PCT/US19/22384 (Atty. Dckt. No. KRTA-0012-WO) entitled “METHODS AND SYSTEMS FOR FILTERING POINT CLOUD MAP DATA FOR USE WITH ACQUIRED SCAN FRAME DATA”, filed Mar. 15, 2019.

PCT/US19/22384 (Atty. Dckt. No. KRTA-0012-WO) claims priority to U.S. Provisional Patent Application Ser. No. 62/643,460 (Atty. Dckt. No. KRTA-0012-P01), entitled “METHODS AND SYSTEMS FOR FILTERING POINT CLOUD MAP DATA FOR USE WITH ACQUIRED SCAN FRAME DATA,” filed on Mar. 15, 2018.

The disclosure of PCT/US18/42346 (Atty. Dckt. No. KRTA-0015-WO)(Publication No. WO 2019/018315), entitled “ALIGNING MEASURED SIGNAL DATA WITH SLAM LOCALIZATION DATA AND USES THEREOF,” filed on Jul. 16, 2018, is incorporated herein by reference in its entirety and for all purposes.

### BACKGROUND

### Field

The methods and systems described herein generally relate to the filtering of LIDAR obtained map data. More particularly, the methods described herein are directed to the filtering of map data to obtain increased accuracy when merging existing map data with newly acquired scan frame data.

### Description of the Related Art

There are many applications where an accurate model of a local area is required and common ways of producing these localized models include, but are not limited to, using cameras and LIDAR. These sensors can capture local information within their Field of View (FOV) in one or more scan frames and merge the data obtained therefrom with existing map data.

Such merging often times involves the matching of newly acquired point cloud data from a particular scan frame with similar features in an existing map comprised of point cloud data. In instances where such matching is performed based solely upon information indicative of the position of newly acquired points, localization error may be introduced. For example, points on surfaces that may be perpendicular to one another but which abut one another along a seam or linear expanse may be difficult to distinguish with respect to which surface they form a part of. The same is true in instances where there exist data sparse regions in the map data.

In the description that follows, there are described exemplary and non-limiting embodiments of methods for filtering map data to enhance the efficacy with which newly acquired scan frame data may be localized.

### SUMMARY

In accordance with an exemplary and non-limiting embodiment, a method comprises acquiring with a scanning device a scan frame comprising a point cloud comprising a first plurality of points, attributing each of the first plurality of points with a selected metric, filtering an existing map comprised of a second plurality of points based, at least in part, on the selected metric and localizing each of the first plurality of points to the filtered second plurality of points.

In accordance with an exemplary and non-limiting embodiment, a method comprises acquiring with a scanning device a scan frame comprising a point cloud comprising a first plurality of points, identifying from a subset of the first plurality of points a generally planar surface with which each of subset of the first plurality of points is associated, acquiring at least one second point with the scanning device and associating the at least one second point with the identified generally planar surface.

In accordance with an exemplary and non-limiting embodiment, a method comprises acquiring with a scanning device a scan frame comprising a point cloud comprising a first plurality of points, identifying from a subset of the first plurality of points a first generally planar surface with which each of subset of the first plurality of points is associated and assigning a first normal vector to the first generally planar surface, acquiring with the scanning device a second plurality of points, identifying from a subset of the second plurality of points a second generally planar surface with which each of subset of the second plurality of points is associated and assigning a second normal vector to the second generally planar surface and associating the first generally planar surface with a first side of a wall and the second generally planar surface with a second side of the wall in the instance that a difference between the first normal vector and the second normal vector is approximately one hundred and eighty (180) degrees.

### BRIEF DESCRIPTION OF THE FIGURES

FIGS. 1A-1B illustrate an exemplary and non-limiting embodiment of filtering potential laser matches.

FIGS. 2A-2B illustrate an exemplary and non-limiting embodiment of laser matching.

FIGS. 3A-3B illustrate an exemplary and non-limiting embodiment of extending planar surfaces.

FIG. 4 is a block diagram of a method in accordance with an exemplary and non-limiting embodiment.

FIG. 5 is a block diagram of a method in accordance with an exemplary and non-limiting embodiment.

FIG. 6 is a block diagram of a method in accordance with an exemplary and non-limiting embodiment.

### DETAILED DESCRIPTION

Point cloud data may be acquired, such as by a simultaneous location and mapping (SLAM) system, to describe the physical characteristics of a three dimensional environment. In some embodiments, use of a SLAM system involves the operation of LIDAR to produce a point cloud comprised of a plurality of point locations in 3D wherein each point represents a location in the three dimensional space of the environment.

In accordance with exemplary and non-limiting embodiments, as new points are received from each successive scan frame, a subset of the prior map is selected and utilized to find potential point matches in order to adjust the entire new scan frame. Specifically, point clouds from one scan frame, which may captured at a rate of, for example, one scan frame per second, may be compared to a prior scan frame. As a result, all of the points captured in one second may be compared to all of the points captured in the next second corresponding to a second scan frame. Typically, some of the newly acquired point data are filtered out based on how clean the data are, how sharply curved the data points are, and various other metrics.

In accordance with exemplary and non-limiting embodiments, point normal directions and the vector from the point back to the location from which it was observed are utilized, at least in part, to filter potential false positive point matches that are common in situations such as when observing two sides of the same wall.

In some embodiments, as point data from successive scan frames are stored in a map, additional data are recorded to aid in comparing incoming point cloud data to the data already stored in the map. Specifically, additional information may be stored corresponding to either the angle between the sensor and that point where it was observed or the surface normal at that point. As used herein, “surface normal” refers to a local measure of the orientation of the surface that that point lies on top of. As noted above, in accordance with embodiments of methodologies disclosed herein, one may filter out the data that are compared against the existing map using these additional metrics.

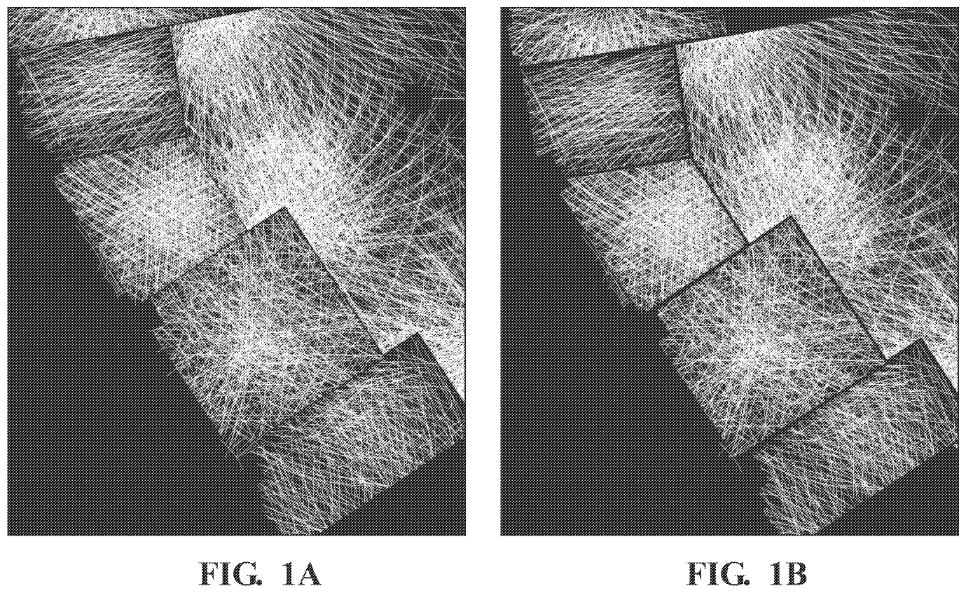

With reference to FIG. 1, there is illustrated an exemplary and non-limiting embodiment of filtering potential laser matches. Specifically, there is illustrated filtering potential laser matches by point normals resulting in improvements in the differentiation of points in different rooms. This can be seen in the improved wall thickness accuracy and the rooms being square and level relative to each other. The two images shown were produced with the same raw sensor data. The map on the left does not filter matches by point cloud normals, while the one on the right does.

Specifically, new points that are received in a scan frame and are measured as corresponding to a wall are matched only to points that are on that wall and not, for example, something sticking out from the wall like a light fixture or a cardboard box sitting on the floor that's close to the wall. For example, consider the instance wherein a box having a generally cubic form abuts a wall along a surface of the box. In this example, four sides of the box extend away from the wall while each extending side abuts the wall along a border of each side. As one moves away from the wall along a side of one such box, points associated with a side are also in close proximity to the wall. In fact, as the box in this example abuts the wall, some points on a surface of the box are coincident with the wall. When one of these points on a surface of the box is considered in isolation and without any additional context or information, it is likely that a point on a surface of the box but near to the wall may be erroneously determined to form a part of the wall. However, in the present example, the point under consideration forms a part of a box side that is generally perpendicular to the orientation of the wall. As a result, one may consider the surface normal of the point and, observing that is at approximately ninety degrees from a normal of the wall surface, one may filter out such a point as matching data from the surface of the wall.

In another example, consider a map that includes data describing a first side of a wall in a first room wherein opposing first and second sides of the wall are observable from different rooms each sharing the wall as a barrier. If one leaves the first room and enters into the second room one may rotate around to scan the second side of the wall. Assuming the wall is relatively thin in terms of thickness, the points received from frame scans corresponding to the second wall will appear to be uniformly close to those of the first side. It is also the case that both the surface normals of each opposing wall side and the direction to the instrument from which each point was acquires are approximately one hundred and eighty (180) degrees out of synch. Therefore, if one filters from the map all points having normal or direction of acquisition vectors with a value greater than a predetermined value, e.g., one hundred and sixty (160) degrees, two advantages arise. First, the possibility of mapping points on the second wall side to the first wall side is eliminated. Second, it is substantially more quickly apparent that the points acquired from the second wall side form a previously unscanned surface.

In the previous example, it is further the case that, as with the box example, it is possible when entering into the second room that a side wall shares a border with, for example, the first wall side. As with the box example, the points of the side wall closest to the first wall side may be difficult to differentiate from the first wall side absent normal or direction acquisition information.

In short, when faced with the problem of considering a lot of points in proximity to each other but which are not easily differentiated from another on the basis of which surfaces they describe, one may ascribe surface normal information or data acquisition direction information to each point and use such information to separate points making the resultant scan or a resultant map much more accurate.

Having discussed the use of surface normals in filtering map data, it is noted that the use of surface normals applied to point data is not without some difficulties. One difficulty with the use of surface normals as described above is that one generally needs to have a lot of data around each point to estimate the local surface and, hence, the normal vector. As a result, if one observes data in a new room, there may not be sufficient local data to inform one where the surface normal is. As a proxy for the surface normal one may use the view direction, which is the angle between the point and the 3D scanner at the moment that it was observed.

For example, consider a scan frame acquired upon entering into a previously unscanned room. In such an instance, the scan frame data is likely to comprise large volumes of sparse or missing data, particularly with regards to a wall that is, for example, ten or fifteen meters away from the scanner. In such an instance, some of the points might be spaced such that there's only one point and the next closest point is, for example, a half of a meter away. As a result, one may not have enough data to estimate the surface normal accurately. However, storing the angle to the sensor (i.e., “data acquisition vector”) as a proxy for a surface normal in the present example is of similar utility to a surface normal as described above when entering a previously unscanned room. While the use of proxy data acquisition vectors is not as accurate as the use of computed normal vectors, such data acquisition vector use is often times sufficient to enhance the mapping of point data as described above with reference to normal vectors.

In accordance with exemplary and non-limiting embodiments, as data from subsequent scan frames are added to a map, one may assign a confidence level attribute to each point, to all points of a scan, or preferentially to sub-portions of a scan to indicate the degree of confidence one has in the spatial accuracy of each point's determined location. Then, when one seeks to match subsequent points from successive scan frames to the map, one may preferentially give priority to map points having a relatively higher confidence level. In one embodiment, when matching a scan frame to an existing map, one may drop from consideration all of the map points having a confidence level below a predefined threshold such as, for example, the bottom 20% of points in terms of location confidence. Using such a threshold helps to avoid the situation wherein a single bad scan comprised of offset point locations having low confidence levels would tend to pull future data points towards the bad data

In accordance with an exemplary and non-limiting embodiment, another point metric that may be utilized when filtering map data in order to improve the scan matching of acquired points is the density of the map points utilized to match against. For example, if one observes data in a completely new area of the map that has not been previously scanned as might happen if the scanner is turned around 180 degrees quickly, most of the data in the map around the newly observed points are situated in relatively low density areas.

This fact operates to limit how fine the alignment between the current scan frame and the matched map data can be because of the limited corresponding data in the map. As a result, one may filter so as to use the densest, most well observed portions of the map when performing scan point matching. Specifically, when one performs matching of what points in a current frame match to the map, one considers the local density around the points being matched to obtain a sense of how fine that match is.

If a newly acquired point is, for example, five meters from the closest point in the map built so far then, even if the two points are matched, the precision of the resulting alignment is relatively coarse because there isn't a lot of support on the map. If, however, one has a relatively high data density in the map in the vicinity of a newly observed point, then one going may to be able to figure out where that new point resides much more precisely. One method of defining the desired data density for such filtering involves thresholding how far one looks around new data to find data in the map.

In some embodiments, as one adds newly acquired points to an existing map and adjusts the positioning of each point in the x, y and z directions, one may also accumulate and attribute each point with a metric related to how many points were previously observed within a thresholded distance (e.g., 10 centimeters) from each new point. As a result, the point data comprising the map may be updated either in real or near-real time with an attribute reflecting the average data density used to map each point. In some embodiments, the thresholded data density value may be continuously adapted based on the structure of the existing map.

In these embodiments the map may be spatially downsampled after each addition of new data points. This downsampling may include an averaging step in which points within an x-y-z box, or voxel, are averaged to determine the location of a single point to leave in the map. In this case, a representative density may then be assigned based on the number of points that were averaged to create that new map point. This value may then be used to weight the point in map matching as well as in future downsampling steps.

This measure of density is calculated by examining the Euclidian distance of nearby points within a specific range. This range can be adaptable according to context or the local environment. The density value is reflected in the number of points per volume, e.g., 100 points per 10 cm voxel. Local structure may be used as a measure to decide what the threshold should be for particular operations on these points. This might include a reduction in the number of points viewed or for calculations involving surface construction for meshing as a one non-limiting example.

In accordance with other exemplary and non-limiting embodiments, data may be filtered based, at least in part, upon the distance from the SLAM system scanner to each point at the time that the point is acquired. Consider the following example. One observes a whole scan frame of point cloud data and proceeds to match the newly acquired data to the map. However, it turns out that the scanned data was off by, for example, one degree around some axis. As a result, all of the scanned points were slightly off from their actual positions by a small angular amount. While such a small angular error has a very small effect on the absolute location of points close to the scanner, the real distance offset of such an error can become quite large at large distances from the scanner. As a result, points that are observed very close to the scanner are going to be off by a small amount while far away points may be off by, for example, 30 centimeters or more.

As a result, one may filter the map data so as not to match newly received points that are more than a predetermined threshold away from the scanner.

In yet other exemplary and non-limiting embodiments, one may either extrapolate, interpolate or both between points in map data such as, for example, points forming a generally planar surface. For example, even in an instance where there is relatively sparse coverage on a generally planar wall, one might use such information to identify the wall as a planer surface and impose extra constraints upon the points forming the wall. Then, if a newly acquired point is not near an existing map point but is likely in the same plane as existing points, then the new point may be mapped to a position coplanar with the previously mapped points. In some instances, once a planar surface having sparse data areas is identified, additional points may be added by interpolation, extrapolation, or both, and added to the map. In such an instance, these generated points will likely be near a newly acquired point that maps to the identified wall.

In other exemplary and non-limiting embodiments, one may enforce assumptions upon new frame scans that may enhance accuracy when adding points acquired therefrom to an existing map. By so doing one may make sure, for example, that when walking from room to room one does not introduce pitch or roll in the new space. For example, once a set of points is determined to represent a generally planar floor, subsequent measurements made after entering an adjoining room maintain the same planar form of the floor. While such an assumption may break down in some cases, it might help in a lot of other cases. In another embodiment, one may also potentially add an assumption that it's likely that there might be two parallel planes with 180 degree opposite normals, as when a wall is scanned from both sides. Using this assumption, one might position the points acquired from a second side of a wall a known distance from the plane corresponding to the first side of a wall based on a known thickness of such walls.

In yet other exemplary and non-limiting embodiments, some of the aforementioned assumptions may be utilized in post-processing of the map data. For example, during post processing one may split up the data into different identified rooms by, for example, manually saving the position that the scanner was at when walking through doorways. Then, one may level the floor of each of those rooms relative to each other and line up the walls relative to each other under the assumption that the walls are parallel and generally perpendicular.

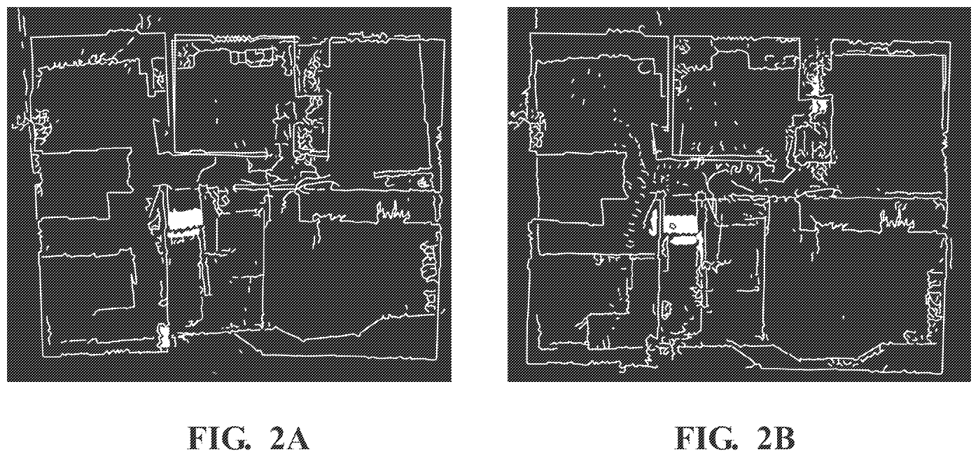

With reference to FIGS. 2A and 2B, there is illustrated an exemplary and non-limiting embodiment of laser matching. In both the left and right image there are illustrated images showing slices taken of a 3D model of two floors of a house. The model shown in FIG. 2A does not filter points for laser matching as described above while the model of FIG. 2B does. There is an observable difference in the squareness of the room and the alignment of the two floors relative to each other.

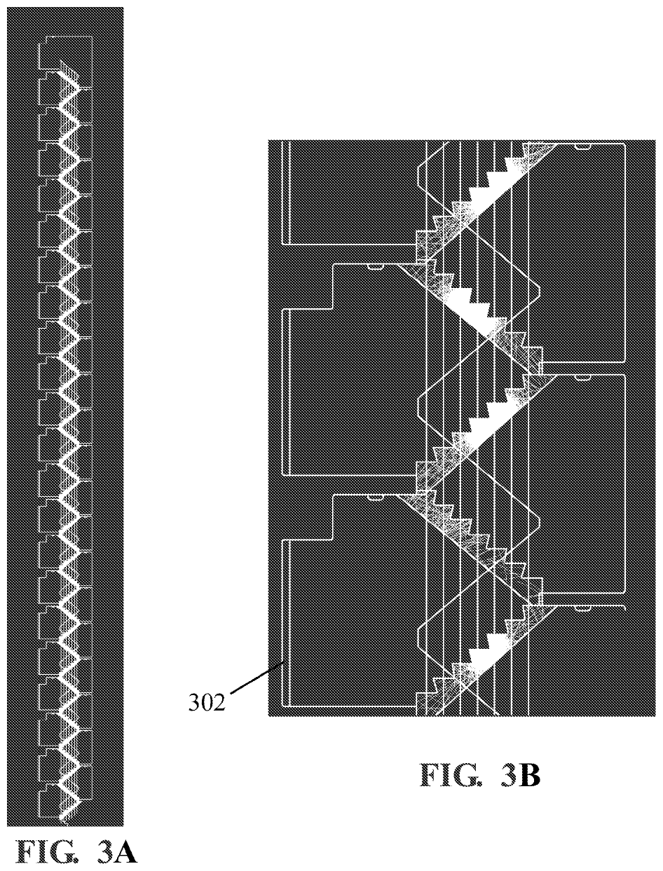

With reference to FIGS. 3A and 3B, there is illustrated an exemplary and non-limiting embodiment of extending planar surfaces. Specifically, there is illustrated extending wall and floor planar surfaces to enable improved mapping of complex environments. As illustrated, the outside walls 302 of a stairwell are extruded up from the first floor as a prior map for matching new data as the user ascends the stairwell. This produces a repeatable stairwell without twists and misalignments that are otherwise common in these challenging environments for scanning.

Plane fitting techniques, such as RANSAC, may be used to extract large planes that are near vertical (e.g., walls) or near horizontal (e.g., floors or ceilings). These planar surfaces may then be temporarily assumed to extend into as yet unmapped regions to help align new data. For example when walking through a doorway, assuming that the floor plane extends tends to prevent pitch or roll errors in the spaces on either side of the doorway. In the case of a long hallway, extending the walls, ceiling and floor can be effective in preventing gradual random drift errors in rotation and hold the hall straight and flat.

The plane of a wall may be extracted mathematically and then boundaries of that plane extended into adjacent regions of a point cloud or map to ensure alignment of a wall via both the vertical and horizontal passing through of walls, floors, and ceilings. In the case of stairwells which require capturing a continuous spiral during ascent or descent, this provides a constraint to ensure alignment between floors. As scanning is extended upwards or downwards, such constraints may ensure alignment between floors of the wall of the stairwell.

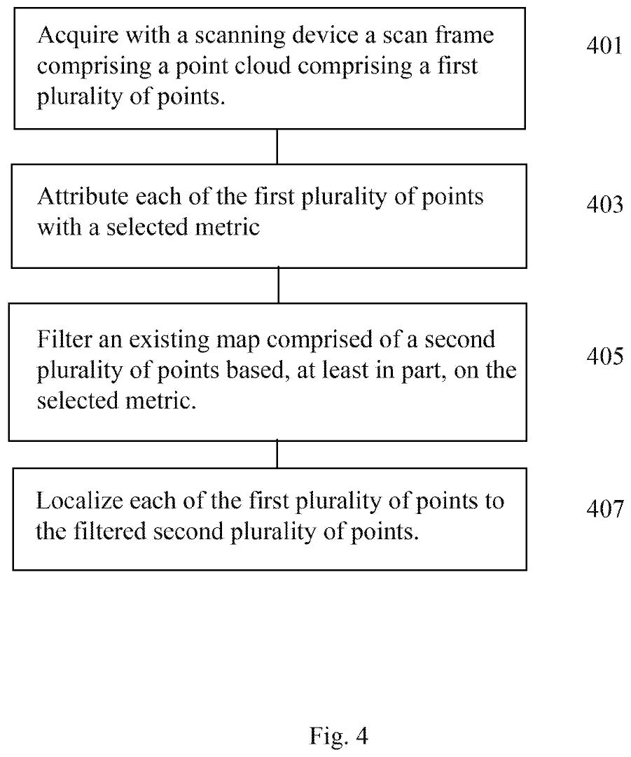

With reference to FIG. 4, there is illustrated an exemplary and non-limiting embodiment of a method. First, at step 401, a scanning device acquires a scan frame comprising a point cloud comprising a first plurality of points. Then, at step 403, each of the first plurality of points is attributed with a selected metric. Next, at step 405, an existing map comprised of a second plurality of points is filtered based, at least in part, on the selected metric. At step 407, each of the first plurality of points is localized to the filtered second plurality of points.

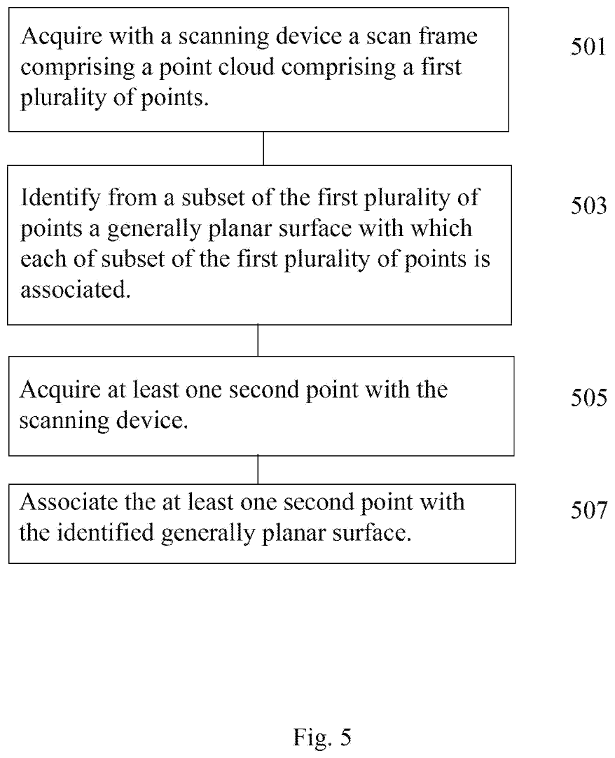

With reference to FIG. 5, there is illustrated an exemplary and non-limiting embodiment of a method. First, at step 501, a scanning device acquires a scan frame comprising a point cloud comprising a first plurality of points. Next, at step 503, a subset of the first plurality of points is identified from a generally planar surface with which each of subset of the first plurality of points is associated. At step 505, at least one second point is acquired with the scanning device. At step 507, the at least one second point is associated with the identified generally planar surface.

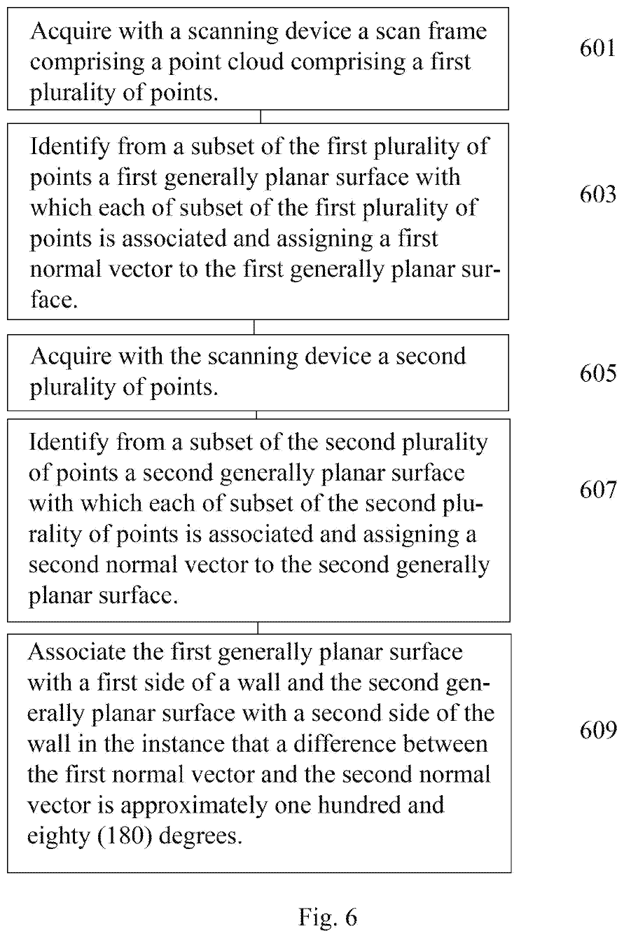

With reference to FIG. 6, there is illustrated an exemplary and non-limiting embodiment of a method. First, at step 601, a scanning device acquires a scan frame comprising a point cloud comprising a first plurality of points. Next, at step 603 a subset of the first plurality of points is identified from a first generally planar surface with which each of subset of the first plurality of points is associated and assigning a first normal vector to the first generally planar surface. At step 605, the scanning device acquires a second plurality of points. At step 607, a subset of the second plurality of points is identified from a second generally planar surface with which each of subset of the second plurality of points is associated and assigning a second normal vector to the second generally planar surface. At step 609, the first generally planar surface is associated with a first side of a wall and the second generally planar surface with a second side of the wall in the instance that a difference between the first normal vector and the second normal vector is approximately one hundred and eighty (180) degrees.

The use of Simultaneous Localization and Mapping (SLAM) devices in the production of point clouds is described, for example, in PCT/US18/42346 (Publication No. WO 2019/018315), entitled “ALIGNING MEASURED SIGNAL DATA WITH SLAM LOCALIZATION DATA AND USES THEREOF,” filed on Jul. 16, 2018, which is incorporated herein by reference in its entirety and for all purposes.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network has sender-controlled contact media content item multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media has sender-controlled contact media content item a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices has sender-controlled contact media content item artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “has sender-controlled contact media content item,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

1.-23. (canceled)

24. A system comprising:
a laser scanning device; and
a computing system in communication with laser scanning device, wherein the computing system comprises at least one processor adapted to software that when executed causes the system to:
acquire with the laser scanning device a scan frame comprising a point cloud comprising a first plurality of points;
attribute each of the first plurality of points with a selected metric;
filter an existing map comprised of a second plurality of points based, at least in part, on the selected metric; and
localize each of the first plurality of points to the filtered second plurality of points.

25. The system of claim 24, wherein the selected metric is selected from the group consisting of a surface normal and a direction from the point to the acquiring device.

26. The system of claim 25, wherein the surface normal is a proxy attribute.

27. The system of claim 26, wherein the proxy attribute is an angle between the laser scanning device and one of the first plurality of points.

28. The system of claim 25, wherein localizing further comprises assigning a confidence level to a spatial accuracy of a portion of the first plurality of points.

29. The system of claim 28, wherein the portion comprises all of the first plurality of points.

30. The system of claim 28, wherein the portion comprises a sub-portion of the first plurality of points.

31. The system of claim 28, wherein localizing further comprises giving a higher priority the portion of the first plurality of points based, at least on part, on the confidence level of each of the portion of the first plurality of points.

32. The system of claim 28, wherein localizing further comprises dropping at least of the portion of the first plurality of points having a confidence level below a predefined threshold.

33. The system of claim 24, wherein the selected metric is a point density of each of the first plurality of points.

34. The system of claim 33, wherein the point density is based, at least in part, on a predefined threshold distance between points.

35. The system of claim 34, wherein the threshold distance is variable.

36. The system of claim 35, wherein the threshold distance varies based, at least in part, on a structure of the existing map.

37. The system of claim 24, wherein the selected metric is a distance from the scanning device of each of the first plurality of points.

38. A system comprising:
a laser scanning device; and
a computing system in communication with laser scanning device, wherein the computing system comprises at least one processor adapted to software that when executed causes the system to:
acquire with a scanning device a scan frame comprising a point cloud comprising a first plurality of points;
identify from a subset of the first plurality of points a generally planar surface with which each of subset of the first plurality of points is associated;
acquire at least one second point with the laser scanning device; and
associate the at least one second point with the identified generally planar surface.

39. The system of claim 38, further comprising computing additional points for association with the generally planar surface.

40. The system of claim 39, wherein computing additional points comprises interpolating among a number of points previously associated with the generally planar surface.

41. The system of claim 39, wherein computing additional points comprises extrapolating from a number of points previously associated with the generally planar surface.

42. The system of claim 38, wherein the generally planar surface represents a floor.

43. The system of claim 42, wherein the at least one second point is acquired after entering into a room that is different from a room in which the first plurality of points was acquired.

44. A system comprising:
a laser scanning device; and
a computing system in communication with laser scanning device, wherein the computing system comprises at least one processor adapted to software that when executed causes the system to:
acquire with the laser scanning device a scan frame comprising a point cloud comprising a first plurality of points;
identify from a subset of the first plurality of points a first generally planar surface with which each of subset of the first plurality of points is associated and assigning a first normal vector to the first generally planar surface;
acquire with the scanning device a second plurality of points;
identify from a subset of the second plurality of points a second generally planar surface with which each of subset of the second plurality of points is associated and assigning a second normal vector to the second generally planar surface; and
associate the first generally planar surface with a first side of a wall and the second generally planar surface with a second side of the wall in the instance that a difference between the first normal vector and the second normal vector is approximately one hundred and eighty (180) degrees.

45. The system of claim 44, wherein the processor further attributes a location of each of a subset of the second plurality of points each location coincident with the second generally planar surface.

46. The system of claim 44, wherein the second generally planar surface is identified as being separated from the first generally planar surface by a predetermined amount.
